(19) United States
(12) Patent Application Publication
(10) Pub. No.: US 2003/0225754 A1
(43) Pub. Date: Dec. 4, 2003

(54) System and method for fair generating data under operation of user

(75) Inventor: Ting-Huang Chen, Taipei (TW)

Correspondence Address: TROXELL LAW OFFICE PLLC, SUITE 1404, 5205 LEESBURG PIKE, FALLS CHURCH, VA, 22041, US

(73) Assignee: WAEI International Digital Entertainment Co., Ltd.

(21) Appl. No.: 10/335,873

(22) Filed: Jan. 3, 2003

(30) Foreign Application Priority Data
May 29, 2002 (TW) 091111501

(51) Int. Cl. G06F 7/00

(52) U.S. Cl. 707/3

(57) ABSTRACT

The present invention provides a data processing system for generating a set of data under operation of a user. The system selectively links to at least data source, and a predetermined algorithm is previously provided. The system comprises a receiving module, a retrieving module, and a processing module. The receiving module receives from the user a request information indicative of request of generating the set of data. The retrieving module receives the designation information from the receiving module, links to the designative data source in accordance with the designation information, and retrieves raw data from the designative data source. The processing module stores the predetermined algorithm, receives the raw data from the retrieving module, and applies the raw data into the predetermined algorithm to generate said set of data.

### FIELD OF THE INVENTION

The present invention relates to a system and method for generating a set of data, in particular, a system and method for fair generating a set of data under operation of a user.

### BACKGROUND OF THE INVENTION

With the development of computer and Internet, many service providers provide service to interact with users such as online games.

When the service provider interacts with users via computer systems, some decisions need to be made for users to go on to the next procedure. For example, in online games, some apparatus, traps, or tools controlled by the computer may appear at irregular timing or in different positions. Those represent the decisions by the computer systems.

For example, the game is finger-guessing. The computer must make a decision like rock, paper, or scissors to compare with the user's decision (rock, paper, or scissors), and the result shows up.

Generally, the computer system stores a p redetermined algorithm in advance. When the computer system makes a decision for a user, the computer system randomly generates a set of data. The data are applied into the predetermined algorithm to generate a result. Then the computer system makes the decision according to the result. Taking the finger-guessing game as for example, the computer system pre-stores a predetermined algorithm that the data will be divided by 3, and when the remainder is zero, the decision is scissors; when the remainder is 1, the decision is rock; when the remainder is 2, the decision is paper. When the system makes a decision for a user, the system generates a set of positive random numbers first, and then applies these numbers into the predetermined algorithm to generate data to further playing with the user.

In another prior art method, the computer system generates a random number when it needs to make decision for the user, and then it makes the decision subsequentially based on the number.

However, the prior art methods of making a decision for a user is like a black box. The procedure is not open, the computer system controls every step, and the decision may not be trusted by user. The data become unconvincing because the user does not know the decision-making procedure.

In another example, the computer system is used to pick numbers randomly on the drawing for users. It must be fair and trusted by users, otherwise, becomes problematic.

### SUMMARY OF THE INVENTION

An objective of the present invention is to provide a data processing system or method for fairly generating a set of data under the operation of the user, and the result can not be known previously. Furthermore, the user can check the accuracy of the result. According to the data, the computer system makes the decision for the user to be sure that the system and the method generate the set of data justly.

The data processing system comprises a receiving module, a retrieving module and a processing module. The data processing system selectively connects to at least one data source. The receiving module receives from a user request information indicative of request of generating a set of data. The request information comprises designation information. The designation information indicates a designative data source. The designation data source is selected from the at least one data source, and will be linked to the data processing system. The retrieving module receives the request information from the receiving module. The retrieving module links to the designative data source in accordance with the request information. The retrieving module retrieves raw data from the designative data source. The processing module stores a predetermined algorithm, and receives the raw data from the retrieving module. The raw data are applied into the predetermined algorithm to generate the set of data.

The present invention can be operated by users and retrieve data from open data source. Therefore the process for generation the data is justly and convincing to users

These and other objectives of the present invention will no doubt become obvious to those of ordinary skill in the art after the following detailed description of the preferred embodiment, which is illustrated in the various drawings.

### BRIEF DESCRIPTION OF THE APPENDED DRAWINGS

FIG. 1 is a schematic diagram of a data processing system according to the present invention.

FIG. 2 is the flow chart of the data processing procedures of the data processing system shown in FIG. 1.

### DETAILED DESCRIPTION OF THE INVENTION

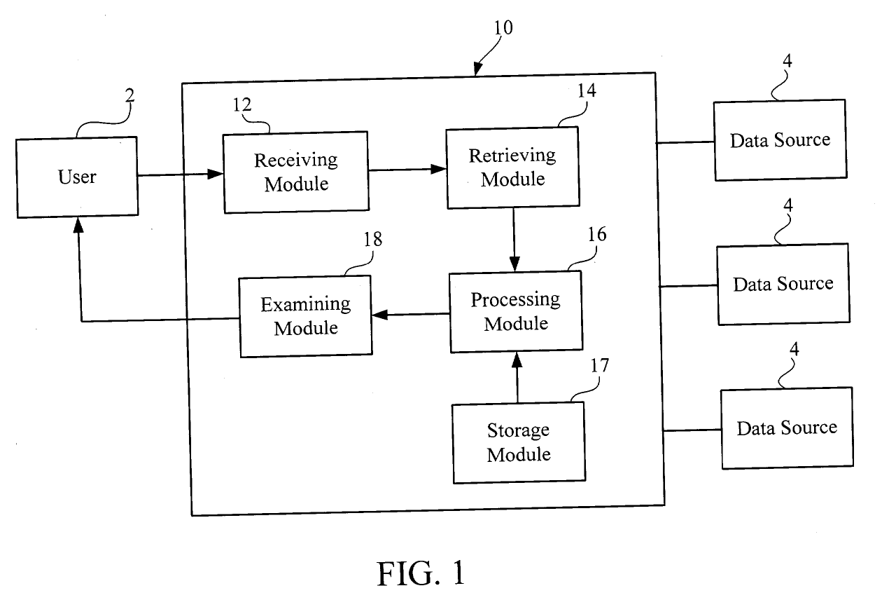

Please refer to FIG. 1. FIG. 1 is a schematic diagram of a data processing system 10 according to the present invention. The data processing system 10 communicates with a user 2. The data processing system 10 selectively links to and communicates with at least one data source. FIG. 1 only shows that the system 10 communicates with one designative data source 4 of the three data source 4, 5, 6. Other data sources don't show in FIG. 1.

The data processing system 10 comprises a receiving module 12, a retrieving module 14 and a processing module 16. The receiving module 12 is for receiving from the user 2 a request information indicative of request of generating the set of data. The retrieving module 14 is for receiving the request information from the receiving module 12, and linking to the designative data source 4 in accordance with the request information. After the data processing system 10 links to the designative data source 4 through the retrieving module 14, the retrieving module 14 retrieves raw data from the designative data source 4.

A predetermined algorithm is previously provided for the data processing system 10. The data processing system 10 further comprises a storage module 17 for storing the predetermined algorithm. The processing module 16 is for receiving the raw data from the retrieving module 14, and applying the raw data into the predetermined algorithm to generate the set of data. In another embodiment (not shown in figures), the data processing system 10 do not further comprises the storage module 17 and the predetermined algorithm is stored in the processing module 16.

To make the raw data unpredictable -and ensure the raw data credible, in one embodiment, each of the data sources 4, 5, 6 has a respective database 42, 52, 62 updated periodically and stores data stamped with an updated time. The raw data are the latest updated data while the retrieving module 14 retrieves data from the designative data source 4.

To allow the user 2 to control the origin of the raw data, the request information comprises a designation information. The designation information indicates a designative data source. The designative data source is selected from the at least three data source 4, 5, 6 and becomes to the designative data source for the retrieving module 14. In FIG. 4, the data source 4 is the designative data source 4. Therefore, the retrieving module 14 links to the designative data source 4 according to the designation information.

To make the data source credible, in one embodiment, each of the at least one data sources 4, 5, 6 is a public website respectively. In one application, the data source 4 can be a real-time information website providing stock information. The retrieving module 14 retrieves the latest stock index during the transaction time only. The data source 4 also can be a real-time information website providing futures information. The retrieving module 14 retrieves the latest futures index during the transaction time only. The data source 4 also can be a real-time information website providing foreign currency exchange information. The retrieving module 14 retrieves the latest foreign currency exchange rates during the transaction time only.

The user 2 can examine that whether the retrieved raw data is justly and whether the set of data is true to ensure that the computer will make a fair decision for the user 2. The data processing system 10 further comprises an examining module 18. After the processing module 16 generate the set of data, the examining module 18 offers the raw data, the time stamped on the raw data, the predetermined algorithm, and the set of data to the user 2. Therefore, the user 2 can examine the justice of retrieving the raw data and the truth of the set of data.

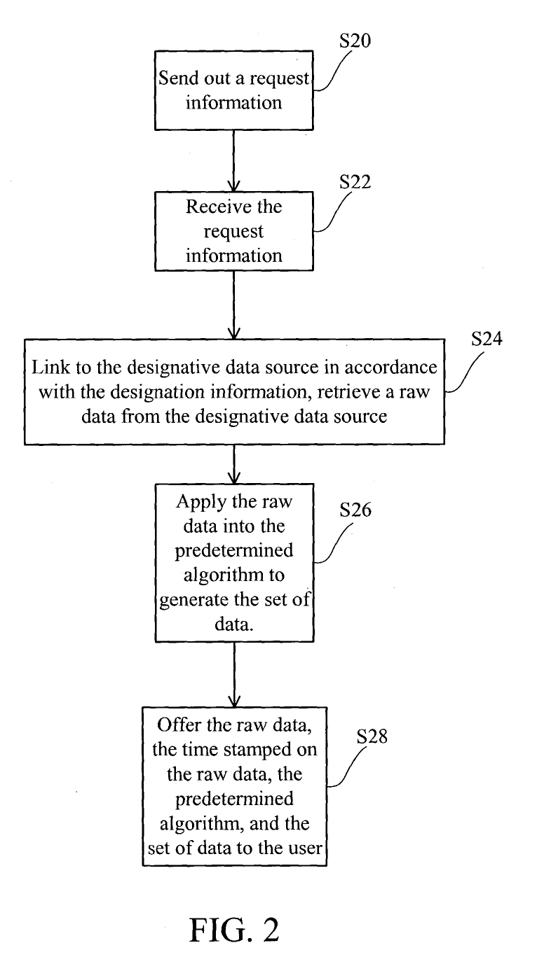

The following paragraphs will describe the data processing procedures of the data processing system 10 according to the preferred embodiment of the present invention. Please refer to FIG. 2. FIG. 2 is the flow chart of the data processing procedures of the data processing system 10 shown in FIG. 1. First, in step S20, the user 2 sends out a request information to the data processing system 10. The request information indicates the data processing system 10 to generate the set of data.

In step S22, the data processing system 10 receives the request information from the user 2. In step S24, the data processing system 10 links to the designative data source 4 in accordance with the request information, and retrieves raw data from the designative data source 4. To allow the user 2 to control the origin of the raw data, the request information comprises a designation information indicating the designative data source 4. The designative data source 4 is selected from the at least one data sources 4,5, 6 and is about to link to the data processing system 10. In step S24, the data processing system 10 links the designative data source 4 according to the designation information.

In step S26, the raw data are applied into the predetermined algorithm to generate the set of data. In step S28, the data processing system 10 offers the raw data, the time stamped on the raw data, the predetermined algorithm, and the set of data to the user 2, whereby the users 2 can examine the justice of retrieving the raw data and the truth of the set of data.

Here is an application of for the present invention, the game of finger guessing. In this application, the predetermined algorithm is to divide the raw data by 3, and make the decision based on the calculation. When the remainder is zero, the decision is scissors; when the remainder is 1, the decision is rock; when the remainder is 2, the decision is paper. When an user requests the computer system to start playing the game of finger guessing, the data processing system of the computer system receives the request to start the game by the receiving module, according to the present invention. The user can designate the data source for retrieving raw data, so that the user designate the website of stock information. The retrieving module links to the designative data source, the website of stock information, and retrieves raw data from the website.

Then the processing module applies the raw data into the predetermined algorithm to generate the set of data to further generate either scissors, rock, or paper to play with the user. Besides, according to the present invention, the examining module offers the raw data, the time stamped on the raw data, the predetermined algorithm, and the set of data to the player on the monitor so that the user can examine the justice of retrieving the raw data and the truth of the set of data. If the player loses the game, he won't blame to the computer system not justified, only his bad luck.

The characteristics of the present invention can be summarized as the following:

(a) According to the invention, the data source is open, the source of the raw data is public and unpredictable. Therefore, the process for generation the data is justly in the present invention.

(b) The user 2 can examine the raw data, the algorithm and the final data to eliminate his/her doubts or distrust, and hence the user will trust following decisions made by the computer system.

(c) The data source is stable. Through the Internet, the data processing system can retrieve real time raw data.

Those skilled in the art will readily observe that numerous modifications and alterations of the device may be made while the teaching of the invention. Accordingly, the above disclosure should be construed as limited only by the metes and bounds of the appended claims.

What is claimed is:

1. A data processing system for generating a set of data under operation of a user, said system selectively linking to at least data source, a predetermined algorithm being previously provided, said system comprising:
a receiving module for
receiving from said user a request information indicative of request of generating said set of data;
a retrieving module for
receiving the designation information from said receiving module,
linking to the designative data source in accordance with the designation information, and
retrieving raw data from the designative data source; and
a processing module for
storing the predetermined algorithm,
receiving the raw data from the retrieving module, and
applying the raw data into the predetermined algorithm to generate said set of data.

2. The data processing system of claim 1, wherein each of the at least data source is open.

3. The data processing system of claim 2, wherein each of the at least one data source has a respective database updated periodically and storing data stamped with updated time, the raw data is the data updated last while the retrieving module retrieves data from the designative data source.

4. The data processing system of claim 3, wherein the request information comprises an designation information indicative of a designative data source, selected from the at least one data source, to be linked, and the retrieving module links to the designative data source according to the designation information.

5. The data processing system of claim 4, wherein each of the least one data source is an open website respectively.

6. The data processing system of claim 5, further comprising an examining module for offering the raw data, the time stamped on the raw data, the predetermined algorithm, and the set of data to said user whereby said user can examine the justice of retrieving the raw data and the truth of the set of data.

7. A data processing method for generating a set of data under operation of a user, said system selectively linking to at least one open data source, a predetermined algorithm being previously provided, said method comprising the steps of:
receiving from said user a request information indicative of request of generating said set of data;
linking to the designative data source in accordance with the designation information;
retrieving raw data from the designative data source;
applying the raw data into the predetermined algorithm to generate said set of data.

8. The data processing method of claim 7, wherein each of the at least data source is open.

9. The data processing method of claim 8, wherein each of the at least one data source has a respective database updated periodically and storing data stamped with updated time, the raw data is the data updated last while the retrieving module retrieves data from the designative data source.

10. The data processing method of claim 9, wherein the request information comprising an designation information indicative of a designative data source, selected from the at least one data source, to be linked.

11. The data processing method of claim 10, wherein each of the least one data source is an open website respectively.

12. The data processing method of claim 11, further comprising a step of offering the raw data, the time stamped on the raw data, the predetermined algorithm, and the set of data to said user whereby said user can examine the justice of retrieving the raw data and the truth of the set of data.
